(19) United States
(12) Patent Application Publication
(10) Pub. No.: US 2004/0004601 A1
(43) Pub. Date: Jan. 8, 2004

(54) Virtual position movement capturing apparatus

(76) Inventor: Luke Wu, Ilan (TW)

Correspondence Address: BIRCH STEWART KOLASCH & BIRCH, PO BOX 747, FALLS CHURCH, VA, 22040-0747, US

(21) Appl. No.: 10/378,740

(22) Filed: Mar. 5, 2003

(30) Foreign Application Priority Data
Jul. 2, 2002 (TW) 091114645

(51) Int. Cl. G09G 5/08

(52) U.S. Cl. 345/157

(57) ABSTRACT

A virtual position movement capturing apparatus includes a light emission unit, a reflection unit and a light receiving unit to define the position and movement of an user's finger, and generate corresponding signals of movement, single click, double click and drag to a computer system for issuing control commands to a graphical user interface to order the computer to operate.

### FIELD OF THE INVENTION

The invention relates to a movement capturing apparatus and particularly a movement capturing apparatus on a virtual position.

### BACKGROUND OF THE INVENTION

A mouse is one of the standard computer peripheral devices. It is a tool to help the user to manipulate the computer on the Window interface or Graphical User Interface. By means of the mouse controlling the pointer (cursor) on the Windows system, users do not need to remember or enter complicated commands to operate the computer. The conventional mouse adopts a control principle that transforms the horizontal movement of the mouse to the rotation of a track ball located in the mouse, and consequently drives two code translation wheels on the X-axis and Y-axis to rotate. Through recognition of electric brushes or photosensitive elements in the mouse, precise coordinating values may be obtained. For such type of mouse, interior cleaning is very important.

There are many variations based on the aforesaid mouse. The most popular ones on the market are the two-button mouse, the three-button mouse and the roller mouse. The three-button mouse uses the third button to replace the original double click operations. The roller mouse has a wheel on the conventional mouse that may be turned by the user's middle finger to operate the scroll function on the Windows system. It is very convenient for browsing Web pages and length documents.

The nucleus of the mouse operation is to transfer the mouse movement to the computer through a signal line and transform to a corresponding cursor track. The track ball and coordinating code translation wheel are the methods and devices to transform the mouse movement to the cursor movement. Based on this concept, many improvements of the mouse have been developed and introduced. For instance, there is a mouse using a track ball to control the cursor movement position and enable users to directly turn the ball located on the mouse to control the movement of the mouse. The advantage of such a mouse is that user does not need to move the wrist to control the mouse and positioning is more precise. However, the track ball easily attracts dust. This hinders its acceptance to users. This concept has been adapted to many other types of mouse, such as the touch control stick on IBM's notebook computers, touch control plates on some other notebook computers, etc.

There is also a technically advanced mouse such as the optical mouse. It adopts a principle similar to the conventional mouse. It has an optical encoder to replace the roller encoder of the conventional mouse to position the cursor on the screen. Light variation is detected by the mouse and is transformed to a signal which is transferred through a signal line or a wireless transmission interface to the processor to derive the result and distance of the movement. There is no track ball on the bottom of the mouse. While the conventional mouse employs the movement of the ball in the roller encoder to transform the direction and distance of the pointer on the screen, the rolling ball moving on the table tends to carry floss and dust into the roller encoder which creates an inflexible movement. The mouse must be cleaned and cleared frequently. The optical mouse which functions by light detection does not have such concerns. Moreover, without the rolling ball, the mouse becomes lighter, and users may manipulate easier without causing muscle fatigue or suffering.

The mice mentioned above all have an encoder to transform the movement position to the movement position of the cursor on the screen, such as the track ball or optical encoder. The invention aims at providing a mouse that uses a new type of encoder reducing the space required on the table top so that more space may be spared to accommodate other computer peripheral devices and wiring.

### SUMMARY OF THE INVENTION

The primary object of the invention is to provide a virtual position movement capturing an apparatus that employs light emission and receive reflecting light to define user's finger position and movement, and to transform the captured photo signal to a corresponding cursor movement to issue an operation command to the computer.

In order to achieve the foregoing object, the apparatus of the invention includes:

a main body which has an upper end to house an emission unit to project a virtual position on a flat surface;

a reflection unit which is attached to a finger of a user or a pen-like element. When the user moves a finger on a virtual position, the reflection unit is moved to reflect the light of every position, and

a sensor unit located at an optimal position on the same flat surface where the main body and the emission unit are located to receive and detect the reflecting light of every position. The detected photo signal of different positions is used to determine the movement and position of the cursor on the screen.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a first embodiment of the invention.

FIG. 2 is a schematic view of a second embodiment of the invention.

FIG. 3 is a schematic view of a third embodiment of the invention.

FIG. 4 is a schematic view of the reflection unit of the invention.

FIG. 5 is a schematic view of another reflection unit of the invention.

### DESCRIPTION OF THE PREFERRED EMBODIMENTS

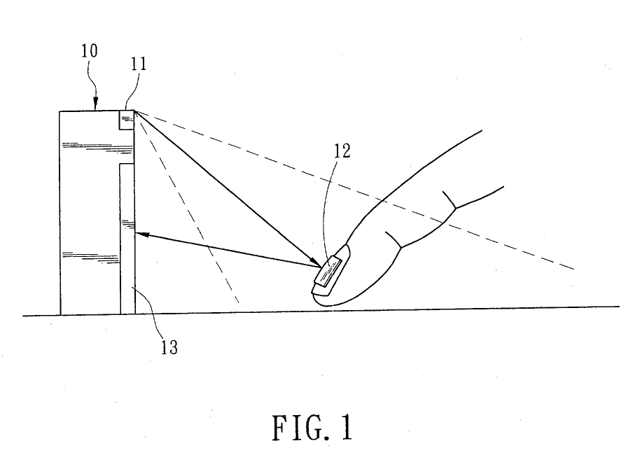

Refer to FIG. 1 for the structure of the virtual position movement capturing apparatus of the invention. The apparatus includes a main body 10 which has an upper end to house an emission unit 11 to project a virtual position on a flat surface that is larger than the movement range of the cursor on the screen, and a reflection unit 12 which is attached to a user's finger or a pen-like element. When the user moves the finger on the virtual position, the reflection unit 12 is moved to reflect the light of every position. Further, the main body has a sensor unit 13 located at an optimal position receiving the reflecting light on the same flat surface where the main body 10 and the emission unit 11 are located to detect the reflecting light of every position. The detected photo signal of different positions is used to determine the movement and position of the cursor on the screen.

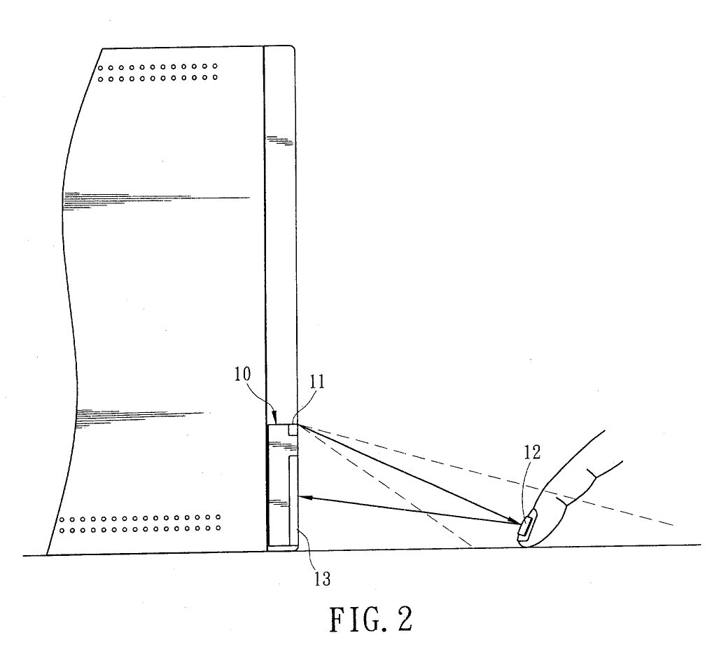

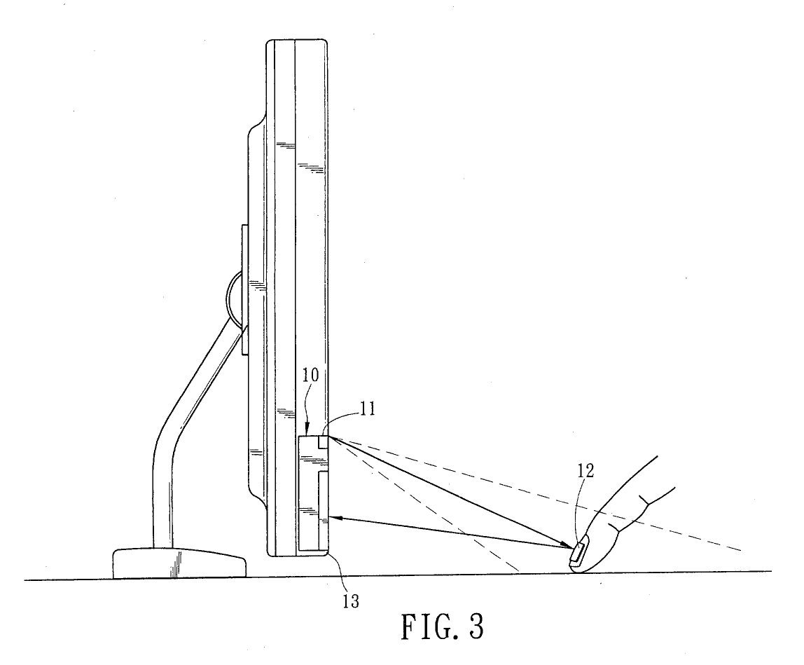

The main body 10 that holds the emission unit 11 and the sensor unit 13 may be an independent device as shown in FIG. 1, or be embedded in an information processing facility such as a Personal Digital Assistant (PDA), personal computer, notebook computer, or a graphical user interface that uses a cursor to issue commands, as shown in FIGS. 2 and 3.

Referring to FIG. 1, the emission unit 11 projects a virtual position on a flat surface that defines the movement range of a virtual mouse (i.e. the reflection unit attached to user's finger), i.e. the maximum scope which user's linger may move. The rectangular area bordered by four corners of the display area of the screen indicates the movable distance of the cursor. The corresponding actual movement distance is at least the same as the corresponding relative movement distance, reflecting light as desired.

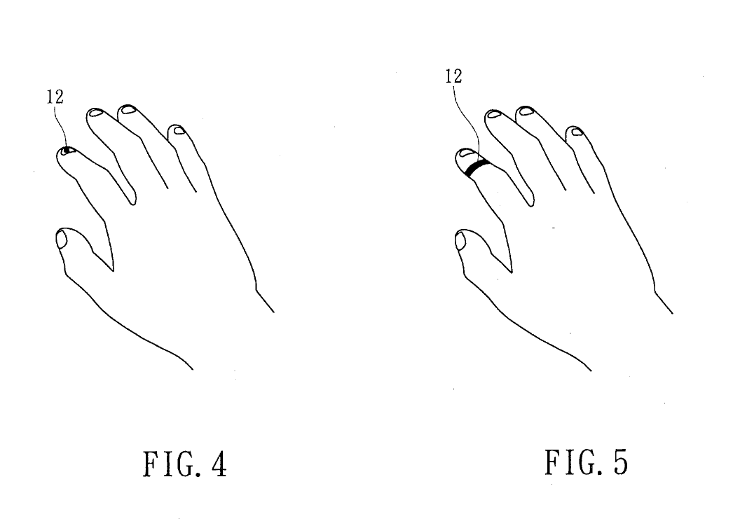

Recognition of the movement of the virtual mouse is achieved through the reflection unit 12 and the sensor unit 13. The reflection unit 12 is bonded to a user's finger, and may be a gloss flake, a ring or a reflective element as shown in FIGS. 4 and 5. Moreover, it may also be user's fingernail surface. In such a circumstance, it is advisable to cover a layer of coating material that has a desired reflective index on the finger nail to obtain the required reflecting effect.

When the user moves on the virtual position defined by the reflection unit 11, light projecting on the reflection unit 12 is reflected to generate a reflecting light. The sensor unit 13 continuously detects whether the reflecting light exists. When the reflection unit 12 is moved, a reflecting light is generated and received by the sensor unit 13 which transforms the received reflecting light to a corresponding position of the cursor on the screen.

In general, a conventional mouse has a left and a right button to couple with a track recognition device to generate a movement track on the screen corresponding to the movement of the mouse. To couple with the operation of the left and right button to manipulate the computer software through the graphical user interface, the operation movements of the aforesaid elements include: 1. Movement, 2. Single Click, 3. Double Click, 4. Select, 5. Drag. Operations of the invention achieving the same effect of a real mouse are explained as follows:

1. Movement

A conventional mouse is moved by a finger. When a finger is moved from A to B, the reflection unit 12 on the finger continuously reflects the reflecting light. On the track from A to B, every recognition point has a corresponding reflective angle. Thus, its position is determined by the reflective angle, and the corresponding movement is displayed on the screen to accomplish the effect of the cursor movement.

2. Single Click

The single click of a conventional mouse corresponds to the finger depressing the button once. When the finger is moved upwards, its reflective angle also changes. When the finger is moved downwards, the reflecting light is the same as before the movement. Hence, the time of the sensor unit 13 receiving the same reflecting light may be used to determine whether a single click movement is performed.

3. Double Click

On the conventional mouse, a double click consists of depressing the same button twice rapidly. For instance, in a Windows operating system, moving the pointer to the “My computer” icon and pressing the button twice rapidly means that the user wants to activate the function of “My computer”, i.e. a double click represents the order command of executing “My computer”. In the corresponding operation, the user moves the reflection unit 12 twice rapidly at the same position. The sensor unit 13 receives the same reflecting light twice in a short time interval and determines that user wants to double-click. 4. Select

With the conventional mouse, a selected movement is accomplished by moving the cursor to the border of a targeted range, then the single click button is continuously pressed, to generate a marking effect, and the mouse is moved to enclose the selecting targeted range. The corresponding movement of the virtual mouse is moving the finger to the border of the selecting targeted range and stopping there; next, performing a single click and moving back instantly to the same position to generate a mark function; then moving the finger to mark the selected range. To accomplish the operation, the reflecting light on the spot of the mark must be recorded, to record the reflecting light of the movement.

5. Drag

The function of the drag is similar to the selection, and is to move the cursor to a target to be dragged. A single click is performed on the target without releasing and the target is moved to a desired position. Similarly, the user moves a finger to the target to be dragged and performs a single click without releasing the finger to generate a mark by recording the variation of light, then moves the finger corresponding to the target on the screen to accomplish a drag function.

Therefore, by recording, calculating and determining the reflecting light, operation signals sent by the user may be determined to achieve the function of the conventional mouse.

The description set forth above is for the operation of one finger. When performing the two buttons operation with an ordinary mouse, a dedicated function may be designed and set on a selected location on a virtual position. For instance, dividing a virtual position in a left zone, a right zone and a moving zone. When the reflection unit is moved to a selected zone, the sensor unit detects the movement and determines the special function that the user intends to perform, such as the upper left button or the right button function.

By means of the construction set forth above, the virtual position movement capturing apparatus of the invention is a new type of mouse that employs emitting light and receives reflecting light to move a mouse and position recognition. It can reduce the occupied tabletop space.

While the preferred embodiments of the invention have been set forth for the purpose of disclosure, modifications of the disclosed embodiments of the invention as well as other embodiments thereof may occur to those skilled in art. Accordingly, the claims are intended to cover all embodiments which do not depart from the spirit and scope of the invention.

What is claimed is:

1. A virtual position movement capturing apparatus for controlling a cursor of a graphical user interface, comprising:
an emission unit for projecting a virtual position on a flat surface;
a reflection unit for reflecting light of every position of a movement when an user moves the reflection unit on the virtual position; and
a sensor unit for detecting the reflecting light from the reflection unit to determine the movement and position of the cursor.

2. The virtual position movement capturing apparatus of claim 1, wherein the virtual position defines a maximum movement range of the reflection unit.

3. The virtual position movement capturing apparatus of claim 1, wherein the reflection unit is selected from the group consisting of a reflective adhesive flake, a reflective finger ring, a coating material of a high reflective index and a finger nail surface.

4. An information processing apparatus, comprising:
an emission unit located on the information processing apparatus for projecting a virtual position on a flat surface;
a reflection unit for reflecting light of every position of a movement when an user moves the reflection unit on the virtual position; and
a sensor unit located on the information processing apparatus for detecting the reflecting light from the reflection unit to determine the movement and position of the cursor.

5. The information processing apparatus of claim 4, wherein the virtual position defines a maximum movement range of the reflection unit.

6. The information processing apparatus of claim 4, wherein the reflection unit is selected from the group consisting of a reflective adhesive flake, a reflective finger ring, a coating material of a high reflective index and a finger nail surface.

7. A method for capturing a virtual position movement to control a cursor of a graphical user interface, comprising steps of:
projecting a virtual position on a flat surface by an emission unit;
reflecting light of a reflection unit on the virtual position by the reflection unit;
detecting the reflecting light reflected from the reflection unit by a sensor unit; and
determining a track and a movement of the reflection unit according to the detected reflecting light.

8. The method of claim 7, wherein the virtual position defines a maximum movement range of a user.

9. The method of claim 7, wherein the reflection unit is selected from the group consisting of a reflective adhesive flake, a reflective finger ring, a coating material of a high reflective index and a finger nail surface.
